(19) United States
(12) Patent Application Publication
(10) Pub. No.: US 2014/0221052 A1
(43) Pub. Date: Aug. 7, 2014

(54) SWITCH DESIGN FOR LIGHT UP PHONE CASES

(71) Applicant: Eric Schwab, (US)

(72) Inventor: Ruiran Huang, Nankang (CN)

(21) Appl. No.: 13/921,670

(22) Filed: Jun. 19, 2013

(30) Foreign Application Priority Data
Oct. 15, 2012 (CN) 201220526197.9

(51) Int. Cl. H04M 19/04

(52) U.S. Cl. CPC H04M 19/048
USPC 455/567

(57) ABSTRACT

A mobile phone call flashing apparatus equipped with an electronic switch relates to the field of electronic products and comprises an electric power supply, a capacitor, a first resistance, a second resistance, a switch, a first integrated block, a second integrated block, a conductor field effect transistor, and a first light-emitting diode through a sixth light-emitting diode. It can make up the deficiency in the prior art, allow users to be able to control the light-emitting status at the time of incoming calls or messages autonomously, greatly satisfy modern people's psychological needs in their pursuit of fashionable visual effects, and enjoy extensive applicability and market prospects.

### TECHNICAL FIELD

The present utility model relates to a mobile phone call flashing apparatus, and particularly to a mobile phone call flashing apparatus equipped with an electronic switch.

### PRIOR ART

In the existing market, there has been an apparatus whose LED lamp which is set at the bottom of the mobile phone will automatically emit light if the mobile phone receives any incoming call or message, but the apparatus in accordance with the prior art cannot be controlled autonomously when it is not necessary to emit light, which brings inconvenience to people's lives.

### SUMMARY OF THE UTILITY MODEL

The purpose of the present utility model is to disclose a mobile phone call flashing apparatus equipped with an electronic switch; the apparatus can make up the deficiency in the prior art, allow users to be able to control the light-emitting status at the time of incoming calls or messages autonomously, and satisfy modern people's psychological needs in their pursuit of fashionable visual effects.

In order to solve the problem existing in the prior art, the present utility model uses the following technical solution: it comprises an electric power supply E, a capacitor C, a first resistance R1, a second resistance R2, a switch SW, a first integrated block U1, a second integrated block U2, a conductor field effect transistor Q1, and a first light-emitting diode through a sixth light-emitting diode LED1-LED6, wherein the negative electrode of the electric power supply E is grounded, the positive electrode of the electric power supply E is respectively connected with one end of the capacitor C, the pin 2 of the first integrated block U1 and the drain electrode of the conductor field effect transistor Q1, the other end of the capacitor C is grounded, the pin 1 of the first integrated block U1 is connected with one end of the switch SW, the other end of the switch SW is grounded, the pin 4 of the first integrated block U1 is grounded, the pin 3 of the first integrated block U1 is connected with one end of the first resistance R1, the other end of the first resistance R1 is connected with the grid of the conductor field effect transistor Q1, the source electrode of the conductor field effect transistor Q1 is respectively connected with the pin 1 of the second integrated block U2, the positive electrode of the first light-emitting diode LED1, the positive electrode of the second light-emitting diode LED2, one end of the second resistance R2, the positive electrode of the fourth light-emitting diode LED4 and the positive electrode of the fifth light-emitting diode LED5, the pin 2 of the second integrated block U2 is respectively connected with the negative electrode of the first light-emitting diode LED1 and the negative electrode of the fourth light-emitting diode LED4, the pin 3 of the second integrated block U2 is respectively connected with the negative electrode of the second light-emitting diode LED2 and the negative electrode of the fifth light-emitting diode LED5, the pin 4 of the second integrated block U2 is respectively connected with the negative electrode of the third light-emitting diode LED3 and the negative electrode of the sixth light-emitting diode LED6, the positive electrode of the sixth light-emitting diode LED6 is connected with the other end of the second resistance R2 and the positive electrode of the third light-emitting diode LED3, the pin 5 of the second integrated block U2 is connected with an antenna ANT, and the pin 6 of the second integrated block U2 is grounded.

In accordance with the present utility model, when the mobile phone receives an incoming call or message, all the LED lamps at the bottom of the mobile phone will emit light, the bottom of the protective shell (case) of the mobile phone and both sides of the protective case will also emit light in different colors, and the colors of the protective shell of the mobile phone will immediately glow with a colorful neon effect; as an electronic switch circuit is additionally provided, the light-emitting status at the time of incoming calls or messages can be controlled autonomously.

The present utility model can make up the deficiency in the prior art, allow users to be able to control the light-emitting status at the time of incoming calls or messages autonomously, greatly satisfy modern people's psychological needs in their pursuit of fashionable visual effects, and enjoy extensive applicability and market prospects.

### DESCRIPTION OF THE DRAWING

FIG. 1 shows a circuit diagram of the present utility model.

### SPECIFIC EMBODIMENT

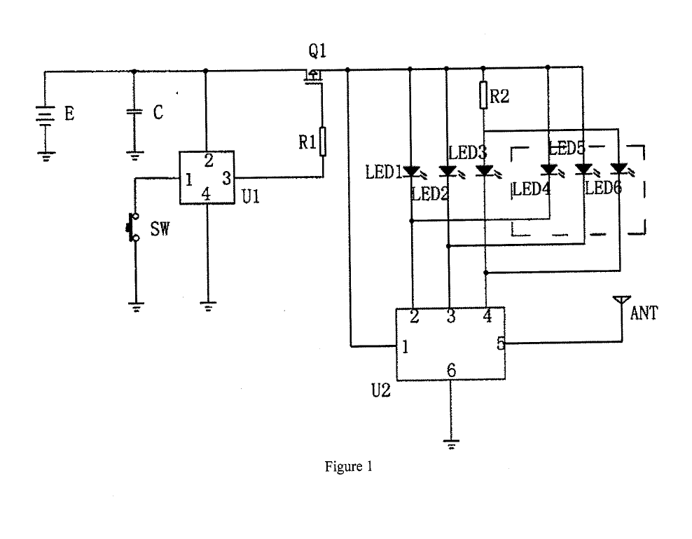

As shown in FIG. 1, the present specific embodiment uses the following technical solution: it comprises an electric power supply E, a capacitor C, a first resistance R1, a second resistance R2, a switch SW, a first integrated block U1, a second integrated block U2, a conductor field effect transistor Q1, and a first light-emitting diode through a sixth light-emitting diode LED1-LED6, [wherein] the negative electrode of the electric power supply E is grounded, the positive electrode of the electric power supply E is respectively connected with one end of the capacitor C, the pin 2 of the first integrated block U1 and the drain electrode of the conductor field effect transistor Q1, the other end of the capacitor C is grounded, the pin 1 of the first integrated block U1 is connected with one end of the switch SW, the other end of the switch SW is grounded, the pin 4 of the first integrated block U1 is grounded, the pin 3 of the first integrated block U1 is connected with one end of the first resistance R1, the other end of the first resistance R1 is connected with the grid of the conductor field effect transistor Q1, the source electrode of the conductor field effect transistor Q1 is respectively connected with the pin 1 of the second integrated block U2, the positive electrode of the first light-emitting diode LED1, the positive electrode of the second light-emitting diode LED2, one end of the second resistance R2, the positive electrode of the fourth light-emitting diode LED4 and the positive electrode of the fifth light-emitting diode LED5, the pin 2 of the second integrated block U2 is respectively connected with the negative electrode of the first light-emitting diode LED1 and the negative electrode of the fourth light-emitting diode LED4, the pin 3 of the second integrated block U2 is respectively connected with the negative electrode of the second light-emitting diode LED2 and the negative electrode of the fifth light-emitting diode LED5, the pin 4 of the second integrated block U2 is respectively connected with the negative electrode of the third light-emitting diode LED3 and the negative electrode of the sixth light-emitting diode LED6, the positive electrode of the sixth light-emitting diode LED6 is connected with the other end of the second resistance R2 and the positive electrode of the third light-emitting diode LED3, the pin 5 of the second integrated block U2 is connected with an antenna ANT, and the pin 6 of the second integrated block U2 is grounded.

In accordance with the present specific embodiment, when the mobile phone receives an incoming call or message, all the LED lamps at the bottom of the mobile phone will emit light, the bottom of the protective shell (case) of the mobile phone and both sides of the protective case will also emit light in different colors, and the colors of the protective shell of the mobile phone will immediately glow with a colorful neon effect; as an electronic switch circuit is additionally provided, the light-emitting status at the time of incoming calls or messages can be controlled autonomously.

The present specific embodiment can make up the deficiency in the prior art, allow users to be able to control the light-emitting status at the time of incoming calls or messages autonomously, greatly satisfy modern people's psychological needs in their pursuit of fashionable visual effects, and enjoy extensive applicability and market prospects.

I claim:

1. A mobile phone call flashing apparatus equipped with an electronic switch, characterized in that it comprises an electric power supply, a capacitor, a first resistance, a second resistance, a switch, a first integrated block, a second integrated block, a conductor field effect transistor, and a first light-emitting diode through a sixth light-emitting diode, wherein the negative electrode of the electric power supply is grounded, the positive electrode of the electric power supply is respectively connected with one end of the capacitor, the pin of the first integrated block and the drain electrode of the conductor field effect transistor, the other end of the capacitor is grounded, the pin of the first integrated block is connected with one end of the switch, the other end of the switch is grounded, the pin of the first integrated block is grounded, the pin of the first integrated block is connected with one end of the first resistance, the other end of the first resistance is connected with the grid of the conductor field effect transistor, the source electrode of the conductor field effect transistor is respectively connected with the pin of the second integrated block, the positive electrode of the first light-emitting diode, the positive electrode of the second light-emitting diode, one end of the second resistance, the positive electrode of the fourth light-emitting diode and the positive electrode of the fifth light-emitting diode, the pin of the second integrated block is respectively connected with the negative electrode of the first light-emitting diode and the negative electrode of the fourth light-emitting diode, the pin of the second integrated block is respectively connected with the negative electrode of the second light-emitting diode and the negative electrode of the fifth light-emitting diode, the pin of the second integrated block is respectively connected with the negative electrode of the third light-emitting diode and the negative electrode of the sixth light-emitting diode, the positive electrode of the sixth light-emitting diode is connected with the other end of the second resistance and the positive electrode of the third light-emitting diode, the pin of the second integrated block is connected with an antenna, and the pin of the second integrated block is grounded.
